(19) United States
(12) Patent Application Publication
(10) Pub. No.: US 2005/0095977 A1
(43) Pub. Date: May 5, 2005

(54) Air inlet fixture, more particularly for attachment on ceilings of clean rooms

(75) Inventor: Walter Hatz, Kajang (MY)

Correspondence Address: BROWDY AND NEIMARK, P.L.L.C.;624 NINTH STREET, NW, SUITE 300, WASHINGTON, DC, 20001-5303, US

(73) Assignee: Gebhardt Ventilatoren GmbH & Co., Waldenburg (DE)

(21) Appl. No.: 10/976,059

(22) Filed: Oct. 29, 2004

(30) Foreign Application Priority Data
Oct. 30, 2003 (DE) 103 50 678.0

(51) Int. Cl. B01L 1/04; E05B 27/00

(52) U.S. Cl. 454/187

(57) ABSTRACT

An air inlet fixture having a housing whose one top side and a housing including a lateral wall is provided at an suction side with a ventilating fan, a discharge opening of the housing being connected functionally with an air filter arrangement and the lateral wall is made up of at least one strip-like section element, several such section elements being able to be connected by coupling means at the their longitudinal sides in an air-tight fashion as a modular system.

### BACKGROUND OF THE INVENTION

The invention relates to an air inlet fixture more especially for attachment to ceilings of clean rooms, comprising a housing, whose one top side and a housing wall having a lateral wall on a suction side is provided with a ventilating fan, an air discharge opening of the housing being able to be coupled with an air filter arrangement.

### THE PRIOR ART

Such air inlet fixtures, which are more particularly suitable for use in clean rooms, are for example disclosed in the German patent publication 29,503,373. Prior art air inlet fixtures or, respectively, air filter feed devices provided with a ventilating fan or blower conventionally have a welded, box-like housing comprising a frame and a cover, the air filter arrangement being permanently connected with this housing, more particularly by weldments or screw connections.

The German patent publication 19,706,144 C1 describes an air inlet fixture, whose housing comprises two mutually parallel lateral walls, between which an arcuate bent casing wall curved toward the air discharge side is arranged, which is connected by means of folds with the two lateral walls. The ventilating fan is located on the top side of the casing wall, whereas the bottom side of the casing wall cooperates with the bottom edges of the lateral walls in defining the air discharge opening.

### SHORT SUMMARY OF THE INVENTION

One object of the invention is to design an air inlet fixture of the type initially mentioned, which is simple and quick to assemble and may be universally employed.

In order to achieve these and/or other objects appearing from the present specification, claims and drawings, in the present invention an air inlet fixture is characterized in that the lateral wall is composed of at least one strip-like section element or part, several such section elements being able to be connected together by coupling means at their longitudinal sides in an air-tight modular fashion. Further developments of the invention are recited in the claims.

The lateral wall of the housing can thus be made up in a modular manner of one or more section elements in order to attain different housing heights or cross sections as may be required. Unlike conventional air inlet fixtures having heavy, single piece and more particularly welded housing frames, the lateral wall or, respectively, the frame of the housing of the air inlet fixture in accordance with the invention may be shipped in separate parts and assembled on site. Accordingly the shipping volume is reduced to be less than that of prior art air inlet fixtures, in the case of which the bulky frame must be shipped as such. Furthermore the modularly designed lateral wall makes it possible to produce an exactly fitting housing which may be placed accurately in position in relation to the corresponding filter frame of the air filter arrangement. Accordingly the housing may be matched and fitted to suit the possibly already completed filter frame, the problem, due to irregular welds or other manufacturing inaccuracies, with prior art arrangements being avoided of the air inlet fixture housing failing to fit its filter frame and more especially fit into the seal groove thereof. The air inlet fixture in accordance with the invention is furthermore characterized by a high mechanical strength and a high vibrational damping effect.

It is convenient for the ventilating fan, which for example may be designed in the form of a radial or axial blower, to be located on the top side of the housing. The top side then constitutes the suction side of the air inlet fixture. Alternatively it is possible for the ventilating fan to be arranged on the lateral wall, for instance if between the top side of the air inlet fixture and a room ceiling over it there is only a small amount of space and a supply of input air from the side appears to be more suitable.

A particularly simple method of production is if the section element is cut off from stock, for instance material in running lengths, to the required length. Accordingly it is unnecessary to take the length into account even during the manufacture of the section element and the section element may be cut to size on site to exactly fit the corresponding filter frame.

It is more particularly preferred to utilize a strand material as stock, which for example may be produced by continuous casting or extrusion.

In the case of a further development of the invention the at least one section element is made of metal and more particularly of a light alloy or metal. As a light metal use is preferably made of aluminum. More particularly it is therefore a question of the section element being in the form of an aluminum extrude. However, it is also possible for the section element to be manufactured of a non-metallic material, as for instance of plastic. Moreover, a combination of metallic and non-metallic materials is possible. As an alternative to light metal the section element can also consist of a metal which is not a light metal, as for example steel and more especially steel sheet. As an alternative to aluminum magnesium may be employed as a light metal.

In a preferred embodiment the housing possesses a rectangular cross section and the lateral wall is defined by four lateral modules, which at least partially consist of a section element. The lateral modules may be joined together with using corner connectors making the corners air-tight. Owing to the modular manner of design of the lateral wall a wide variety of different configurations is possible as regards the cross sectional dimension and the height of the housing. A particularly preferred design involves arranging the section elements in the transverse direction, more especially in the case of a housing with a rectangular cross section, i. e. the plane defined by the longitudinal sides of the section elements extends in parallelism to the cover. The cross sectional dimension of the housing is therefore set by the length of the section elements and the height of the housing is set by its width. Alternatively it is possible to arrange the section elements perpendicularly, i. e. so that their long sides extend at a right angle to the top side, the cross sectional dimension of the housing then being set by the width and the height of the housing is set by the length of the section elements.

In the case of there being several section elements it is possible for all of them to have the same length. In the case of a housing with a rectangular cross section it is possible for either all section elements of each lateral module to be of equal length so that there is a square cross section, or the section elements of the mutually opposite lateral modules may be of equal length so that a rectangular cross section results. Alternatively or in addition it is possible, in the case of there being a plurality of section elements, for all to have the same width. This opens up the possibility of even simpler production, since only stock material of a uniform width must be employed. A variation in the height of the housing may be then gotten more particularly by fitting a different number of section elements together at the transverse side.

Alternatively it is possible to utilize section elements of different width and for instance using inner or outer section elements, the inner section elements, more particularly, being wider than the outer ones if desired.

It is possible to have outer section elements, which each have at least connection section for connection with the top side of the housing and/or with an air filter arrangement. Between the outer section elements inner section elements without connection openings may be provided.

The coupling means for the connection together of a plurality of section element may be designed in the form of plug connections, as for example in the form of a groove and tongue connection. The coupling means may be separate components, to which respectively two section elements to be joined together may be attached. However, it is preferred for the coupling means to be formed using the material of the section elements themselves, and more particularly to form a groove-like receiving socket on the one side of the section element and on the other longitudinal side a pin so that the pin on one section element may lock into the groove of a section element to be secured thereto. The coupling means may have seals integrated in them for producing an air-tight sealing effect between adjacent section elements. The seals may for example be in the form of labyrinth seals.

In the case of a housing with a rectangular cross section it is necessary for the points of engagement, at which respectively two adjacent lateral modules abut, to be connected together in an air-tight fashion. For this purpose the above mentioned corner connectors may be utilized. It is possible to provide one corner connector per corner, which is so designed that all section elements of the lateral modules to be connected can be connected therewith. As a preferred embodiment for the corner connector an L section element is suitable.

In the case of an alternative embodiment the housing may comprise a round and more particularly circularly round cross section. The lateral wall can then be constituted by at least one section element, which is also produced by cutting off from a length of stock and then being bent into a circular shape.

Further advantageous developments and convenient forms of the invention will be understood from the following detailed descriptive disclosure of one embodiment thereof in conjunction with the accompanying drawings.

### LIST OF THE SEVERAL VIEWS OF THE FIGURES

FIG. 1 shows a perspective elevation of an air inlet fixture in accordance with the invention.

FIG. 2 shows a side view of the air inlet fixture and a section taken through the side wall.

FIG. 3 shows on a greater scale the part A of FIG. 2, two joined section elements being shown.

FIG. 4 is a plan view of the air inlet fixture in accordance with FIG. 1.

FIG. 5 shows a section taken through the air inlet fixture on the line D-D of FIG. 4.

FIG. 6 shows the part Y in FIG. 4 on a larger scale, the connection of two section elements at a corner being illustrated.

FIG. 7 is a perspective elevation of a corner connector.

FIG. 8 is a perspective representation of a section element.

### DETAILED ACCOUNT OF WORKING EMBODIMENT OF THE INVENTION

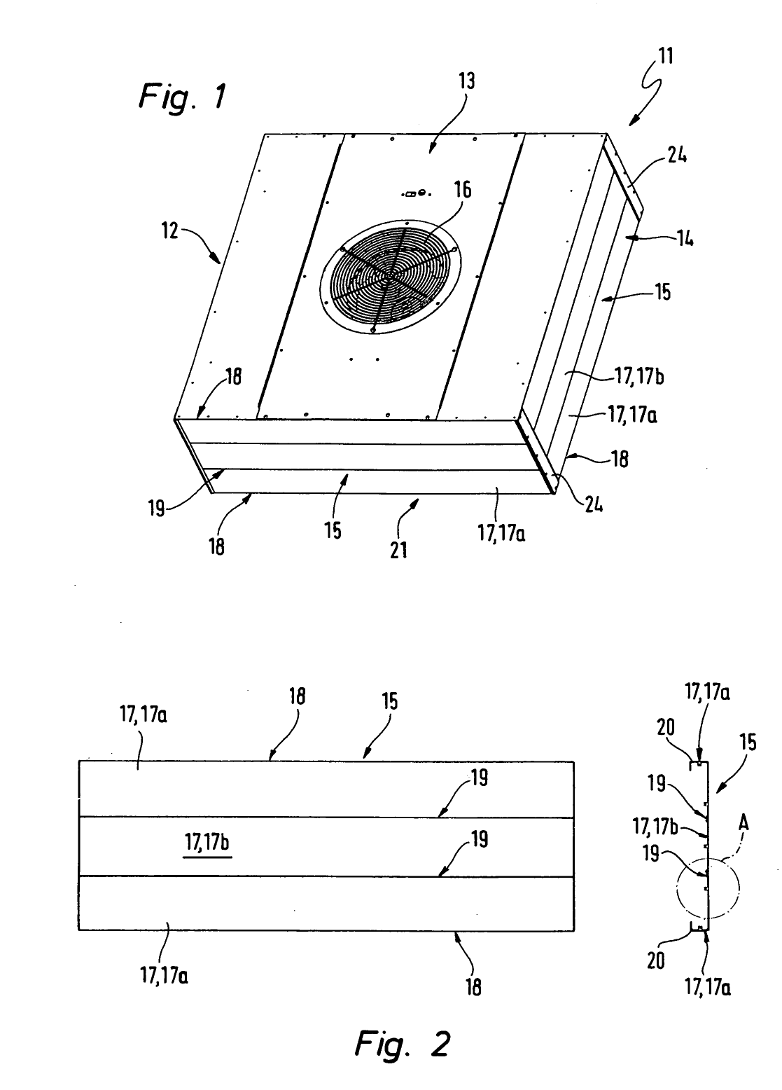

FIG. 1 shows a preferred working example of the air inlet fixture 11 in accordance with the invention. The air inlet fixture 11 of the example consists of a housing 12 with a square cross section. It is naturally possible for other housing cross sections to be employed, as for example a rectangular or round one and more particularly a circular one. The housing 12 possesses a housing wall which is constituted by a top side in the form of a cover 13 and a lateral wall 14 in the form of four lateral modules 15. The cover 13 is for its part made up of several, and more especially three, parts, a generally central receiving opening being provided for a ventilating fan 16, which is more particularly a radial ventilating fan. This fan draws air downward and blows it from the housing 12, more particularly in a radial lateral direction. The ventilating fan 16 may be inserted into the opening from above as premounted, calibrated and adjusted ventilating fan module and fixed to the cover 13.

The ventilating fan 16 is on the suction side provided with a sheet-like prefilter and on its discharge side may possess a hood muffler for silent operation. In lieu of a hood muffler the ventilating fan 16 may also be followed by another muffler, simpler designs not having any muffler and prefilter.

The lateral modules 15 comprise at least one section element 17, the lateral modules 15 in the example comprising several and more particularly three section elements 17. The section element 17 preferably comprises aluminum and more especially is an aluminum extrude, see FIG. 8. For the manufacture of one or more section elements 17 standard stock with a length of for example two or three meters is cut off to the desired length. Accordingly it is possible to cut the section elements 17 on site as desired, to fit same together like a modular unit and accordingly to produce the lateral modules 15.

As shown in FIGS. 1 and 2 the section elements 17 are joined together at their long sides 18 by means of coupling means 19 in an air-tight fashion. In this case the section elements 17 shifted into position in the transverse direction, i. e. the plane defined by the longitudinal sides 18 of the section elements 17 extends in parallelism to the cover 13. It is possible to provide outer section elements 17a, which in the attached state have inwardly projecting connection sections 20, using which they may be secured to the cover 13 by way of attachment means, as for instance screws or, if they are arranged on the bottom side, same define the discharge opening 21. In the case of the inner section elements 17b such a connection section 20 is unnecessary and accordingly not provided either. The section elements 17 may all have the same width so that they can be produced by cutting off from standard section element stock with an equal width. A change in the height of the housing may be then produced by the assembly of a different number of section elements 17 of the same width. It is possible as well for section elements 17 with different widths to be employed, as for example the inner section elements 17b may be made wider than the outer ones.

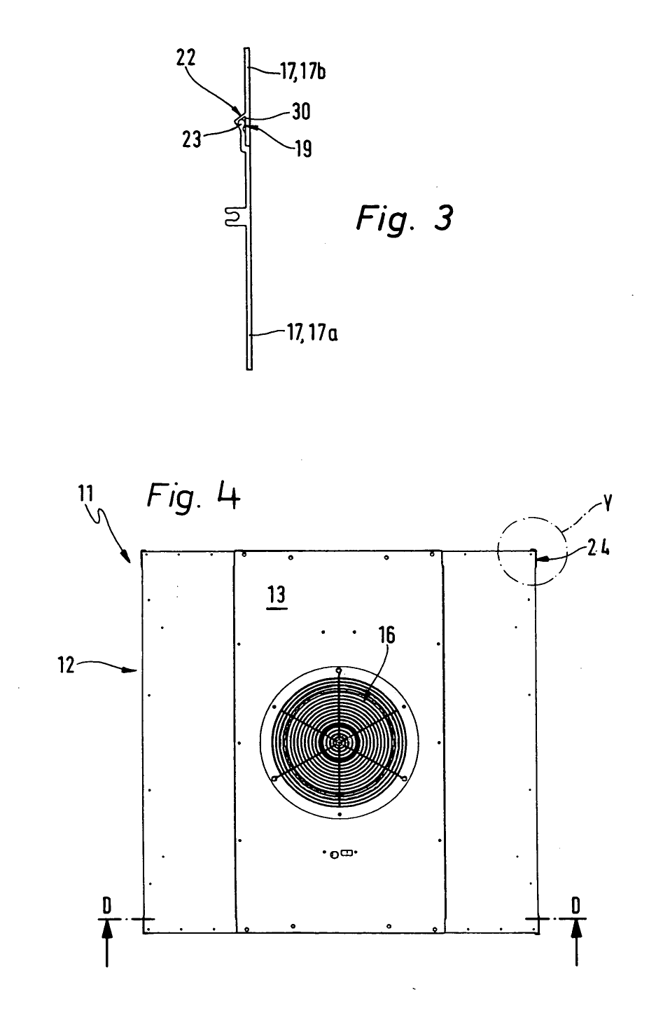

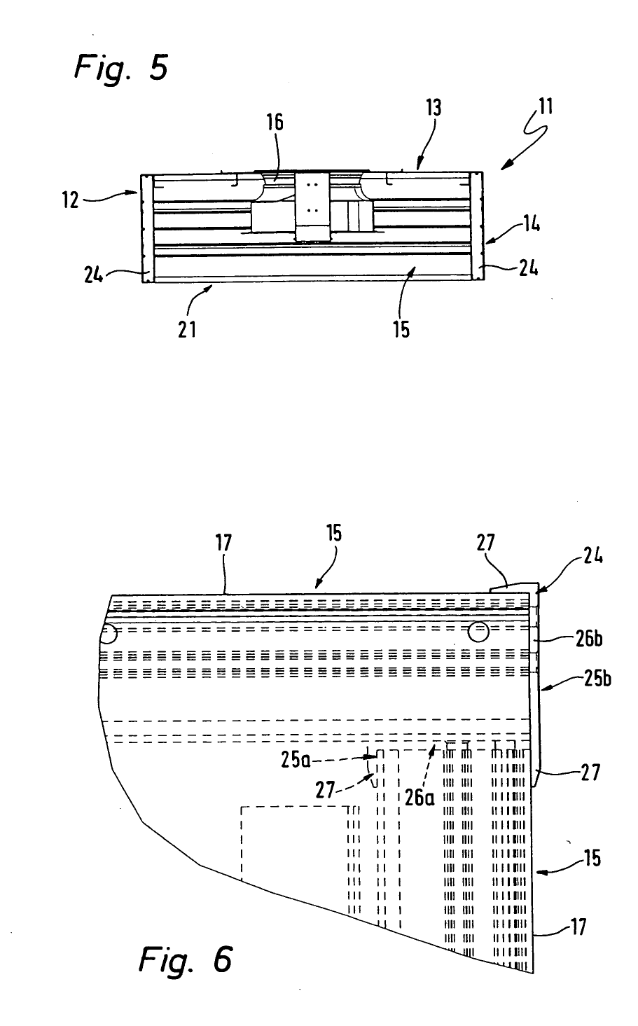

FIG. 3 shows the air-tight connection of two adjacent section elements 17. For this purpose a plug joint with a tongue and a groove may be employed, a groove 22 in the one section element 17 receiving a pin 23 on the other section element 17. In the plug connection a seal 30 is integrated with a labyrinth to ensure that the section elements 17 are connected together in an air-tight fashion. The groove 22 and the pin 23 extend toward the interior of the housing so that at the front side there is a neat, air-tight transition between the joined section elements 17. As illustrated in FIG. 6 the lateral modules 15 are joined together at a corner by means of corner connectors 24. At each corner of the housing 12 there is a corner connector 24, which has the configuration of an L section element extending essentially over the full height of the housing 12.

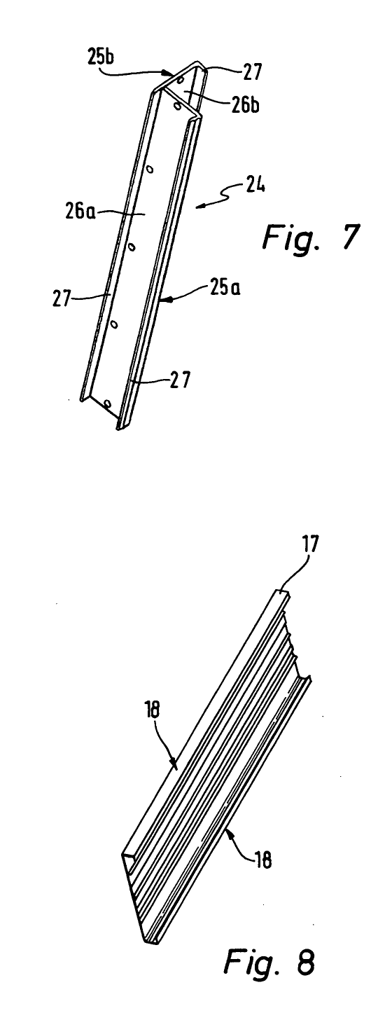

As shown in FIG. 7 the corner connector 24 has two limbs 25a and 25b, more particularly of equal width, at a right angle to one another and which for their part have a base region 26a and 26b bordered longitudinally by one respective guide rail 27 projecting approximately perpendicularly to the front. The clearance width between the guide rails 27 is larger than the thickness of the section elements 17 so that same may be inserted into position and are guided laterally by the guide rails 27. At the base regions 26a and 26b of the limbs there are holes, more particularly drilled ones, by way of which attachment means, not illustrated, may be introduced in order to connect the individual section elements 17 with the corner connectors 24.

1. An air inlet fixture more especially for attachment to ceilings of clean rooms, comprising a housing, whose one top side and a housing wall having a lateral wall on a suction side is provided with a ventilating fan, an air discharge opening of the housing being able to be coupled with an air filter arrangement, wherein the lateral wall is composed of at least one strip-like section element, several such section elements being able to be connected together by coupling means at their longitudinal sides in an air-tight modular fashion.

2. The air inlet fixture as set forth in claim 1, wherein the section element is cut off from stock material to the desired length.

3. The air inlet fixture as set forth in claim 1, wherein such stock material is strand material and more particularly continuously cast material or extruded material.

4. The air inlet fixture as set forth in claim 1, wherein the section element is manufactured of metal and more particularly of a light metal.

5. The air inlet fixture as set forth in claim 4, wherein such light metal is aluminum.

6. The air inlet fixture as set forth in claim 5, wherein the section element is in the form of continuously cast aluminum.

7. The air inlet fixture as set forth in claim 1, comprising several such section elements constituting the lateral wall and all of equal length.

8. The air inlet fixture as set forth in claim 1, comprising several section elements constituting the lateral wall and all having the same width.

9. The air inlet fixture as set forth in claim 1, comprising outer section elements which respectively comprise at least one connection section for connection at the top side of the housing and/or at an air filter arrangement, and/or inner section elements are provided without connection openings.

10. The air inlet fixture as set forth in claim 1, wherein the coupling means for the connection of a plurality of section elements are formed as plug connections.

11. The air inlet fixture as set forth in claim 10, wherein the plug connections are designed in the form of groove and tongue connections.

12. The air inlet fixture as set forth in claim 10, wherein the coupling means comprise integral seals for an air-tight sealing action along each side of adjacent section elements.

13. The air inlet fixture as set forth in claim 12, wherein said seals are labyrinth seals.

14. The air inlet fixture as set forth in claim 1, wherein the housing has a rectangular cross section and the lateral wall is defined by four lateral modules, which each comprise at least one section element, the lateral modules being able to be connected together at a corner in an air-tight fashion.

15. The air inlet fixture as set forth in claim 14, wherein for each corner a respective corner connector is provided, which is so designed that all section elements of the lateral modules to be connected may be attached to same.

16. The air inlet fixture as set forth in claim 14, wherein as corner connectors L section material is utilized.
